(19) United States
(12) Patent Application Publication
(10) Pub. No.: US 2014/0347842 A1
(43) Pub. Date: Nov. 27, 2014

(54) RADIATION GENERATING APPARATUS AND A METHOD OF GENERATING RADIATION

(71) Applicant: CYMTEC LTD, Hengoed (GB)

(72) Inventors: Nigel Joseph Copner, Ebbw Vale (GB); John Kevin Rogers, Pengoed (GB)

(21) Appl. No.: 14/350,075

(22) PCT Filed: Aug. 7, 2012
(86) PCT No.: PCT/GB2012/051910

§ 371 Date: Aug. 12, 2014

(30) Foreign Application Priority Data
Oct. 7, 2011 (GB) 1117334.1

(51) Int. Cl. F21V 9/08; G02B 23/24; G02B 27/14

(52) U.S. Cl. CPC F21V 9/08; G02B 27/141; G02B 23/2461
USPC 362/84

(57) ABSTRACT

Radiation generating apparatus is disclosed. The apparatus comprises a first radiation generating source for generating radiation comprising a first range of wavelengths, a second radiation generating source for generating radiation comprising a second range of wavelengths and a photoluminescent material which is arranged to absorb radiation in the first and second wavelength range and generate radiation comprising a third range of wavelengths. The material comprises a first facet which is arranged to receive radiation from the first radiation source from a first direction and a second facet which is arranged to receive radiation from the second radiation source from a second direction. The first and second directions are substantially collinear, but opposing directions to provide for an increased illumination of the material across the same area of the material.

The present invention relates to radiation generating apparatus and to a method of generating radiation.

Minimally invasive surgery, in which an endoscope is inserted into the body to view internal tissue, has relied on the Xenon light source to provide bright white light illumination for many decades. However, there are a number of disadvantages of this technology including low efficiency, high cost and various ergonomic and usability issues. More recently some light emitting diodes (LED) light sources have been developed for endoscopy, but these provide insufficient power to fully replace the current technology.

A photo-luminescent material has properties whereby it absorbs photons of a particular range of wavelength and radiates photons of a longer wavelength. Typical applications of this technology utilize LED's which are arranged to emit a short narrowband of wavelengths which peak in the range of 285 nm to 460 nm (ultra-violet to blue). These devices are either immersed in or directed at a phosphor for example, which absorbs the short wavelengths and radiates longer wavelengths in the range of 460 nm to 660 nm (blue to red). This design allows a light source which only emits a single colour, to emit several colours, and of particular interest, white light.

However the brightness of light generated using photo-luminescent materials is dependant on how much light is emitted from the light source, such as an LED. Multiple light sources can be used in an array fashion to increase the illumination of the material, but this increases the overall size of the system meaning less light can be coupled into optics for subsequent use.

In accordance with the present invention as seen from a first aspect, there is provided radiation generating apparatus comprising:
a first radiation generating source for generating radiation comprising a first range of wavelengths;
a second radiation generating source for generating radiation comprising a second range of wavelengths;
a photoluminescent material which is arranged to absorb radiation in the first and second wavelength range and generate radiation comprising a third range of wavelengths, the material comprising a first facet which is arranged to receive radiation from the first radiation source and a second facet which is arranged to receive radiation from the second radiation source;
wherein the first radiation source is arranged to illuminate the first facet from a first direction and the second radiation source is arranged to illuminate the second facet from a second direction, which is substantially collinear with the first direction, and wherein, the first and second directions are substantially opposite directions.

Advantageously, the apparatus is arranged to combine different available wavelengths to produce high power white light of sufficient luminance and colour temperature at higher efficiency and lower cost than the Xenon lamp. LED sources are known to generate a maximum optical power which is insufficient for the generation of a sufficiently bright white light from a photoluminescent material, for use in endoscopy.

However, it is found that the illumination of the same region of photoluminescent material from opposite sides thereof with two separate LED sources, for example, provides for an increased photoluminescent generation of radiation which can be suitably captured to generate an improved white light luminance that is suitable for use in endoscopy.

The first and second radiation generating sources are preferably substantially similar sources and the first and second wavelength ranges are substantially similar ranges.

The first and second directions are preferably further collinear with an optical axis of the apparatus. This orientation effectively doubles the illumination of the photoluminescent material while maintaining the emitting area, namely the entendue so that the radiation can be suitably collected from the photoluminescent material.

Preferably, the apparatus further comprises a filter which is arranged to pass radiation in the third wavelength range and substantially reflect radiation in the first and second wavelength ranges. In an alternative embodiment however, the filter may be arranged to pass radiation in the first and second wavelength ranges and reflect radiation in the third wavelength range. This effectively enables the apparatus to operate in a reflection mode or a transmission mode.

The radiation in the second wavelength range is preferably directed upon the second facet by reflecting off the filter. In the alternative embodiment however, the radiation in the second wavelength range is preferably directed upon the second facet by passing through the filter.

The filter is preferably further arranged to pass radiation in at least a sub-range of wavelengths of the first wavelength range. In the alternative embodiment however, the filter is preferably arranged to reflect radiation in a sub-range of wavelengths of the first wavelength range. This effectively enables a sub-range of wavelengths from the first source to combine with those generated by the photoluminescent material to provide a desired wavelength range. Accordingly, in the event that the wavelength range generated by the photoluminescent material is deficient in a range of wavelengths (for example a blue component) required to generate white light for example, then this wavelength range may be supplemented by wavelengths from the first source.

Preferably, the filter comprises a planar disc which is orientated at substantially 45° to the first and second directions and preferably comprises a dichroic filter.

Preferably, the disc comprises at least a reflecting portion and at least a filtering portion which are angularly separated around the disc and the disc is preferably arranged to rotate about an axis which extends though a centre of the disc, substantially perpendicular to the plane of the disc.

The apparatus preferably comprises a third radiation generating source which is arranged to generate radiation comprising the first or second wavelength range. The radiation generated by the third radiation source is preferably arranged to combine with the radiation generated by the photoluminescent material to generate a fourth range of wavelengths. In generating a white light source for example, the filter may remove blue/ultra-violet radiation which may be generated from the first and second radiation sources and as such, the resulting radiation which passes through the filter will lack the blue component for white light production. Accordingly, the third radiation source is arranged to re-introduce the blue component to the photoluminescent radiation to provide a white light radiation.

The radiation generated by one or more of the first, second and third radiation source, together with that generated by the photoluminescent material is preferably enclosed within a housing. The housing may comprise a reflecting cylinder, for example which is found to increase the optical efficiency, by confining the radiation. Alternatively, the housing may comprise a waveguide.

Preferably, the apparatus further comprises at least one radiation collecting arrangement for collecting the radiation which is generated by the radiation sources. The at least one collecting arrangement preferably comprises a lens arrangement and/or a reflecting arrangement.

Preferably, the first and second wavelength ranges comprise at least ultra-violet radiation and the third wavelength range comprises at least a green to red wavelength range of the electromagnetic spectrum. Alternatively, the third wavelength range or as appropriate the fourth wavelength range, spans a visible range of the electromagnetic spectrum to generate substantially white light.

In accordance with the present invention as seen from a second aspect, there is provided a method of generating radiation comprising a range of wavelengths from a photoluminescent material, the method comprising the use of a first radiation source which is arranged to generate radiation comprising a first range of wavelengths and a second radiation source which is arranged to generate radiation comprising a second range of wavelengths, the method comprising the steps of:
illuminating a photoluminescent material from a first direction using radiation from the first radiation source to generate radiation comprising a third range of wavelengths; and,
illuminating the photoluminescent material from a second direction, which is substantially collinear with the first direction and substantially opposite the first direction, using radiation from the second radiation source, to further generate radiation comprising the third range of wavelengths.

The method preferably comprises directing the radiation from the second radiation source in the second direction, by reflecting the radiation off a filter, such as a dichroic filter, which is arranged to substantially pass radiation in the third wavelength range and substantially reflect radiation in the first and second wavelength ranges. In an alternative embodiment, the method preferably comprises directing the radiation from the second radiation source in the second direction, by passing the radiation through the filter.

Preferably, the method comprises combining the radiation generated by the photoluminescent material with radiation from a third radiation source, which is arranged to generate radiation within the first or second wavelength range, to generate a fourth range of wavelengths.

The method preferably further comprises powering at least one of the first, second and third radiation generating sources with a pulsed power supply. The perceived brightness of the radiation generating sources is time averaged and so there can be a need to interleave the radiation generated from the sources. For example, in situations whereby blue radiation components from the first and second sources are be removed by the filter, it is necessary to replace these blue components using the third radiation generating source, to provide a white light source.

Embodiments of the present invention will now be described by way of example only and with reference to the accompanying drawings, in which:

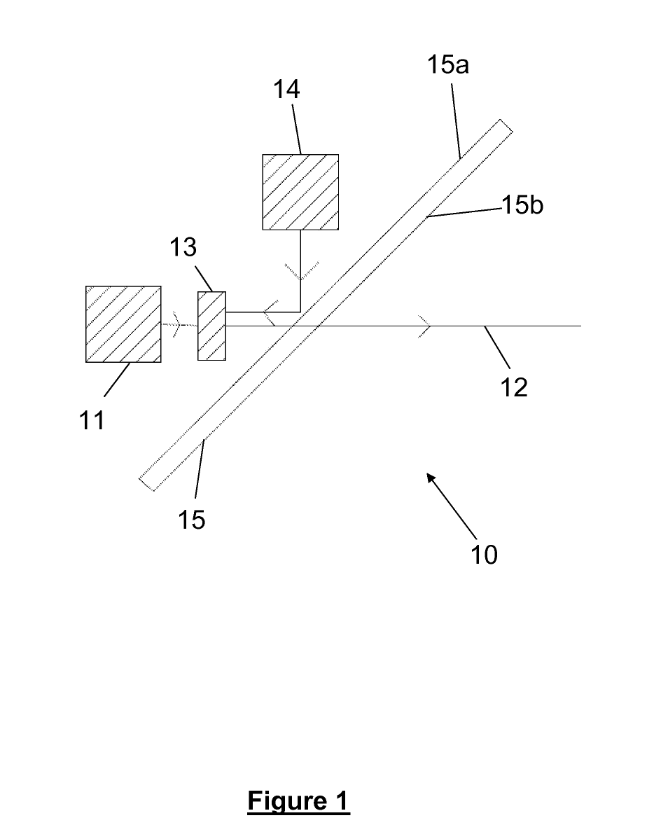

FIG. 1 is schematic illustration of a radiation generating apparatus according to an embodiment of the present invention;

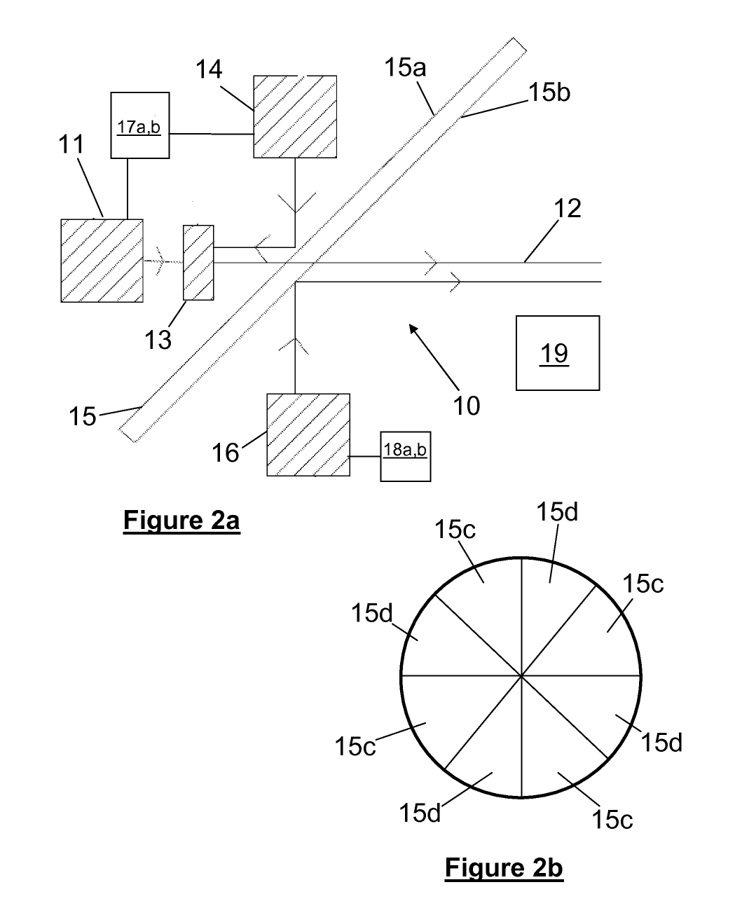

FIG. 2 is a schematic illustration of a radiation generating apparatus illustrated in FIG. 1 comprising a third radiation generating source;

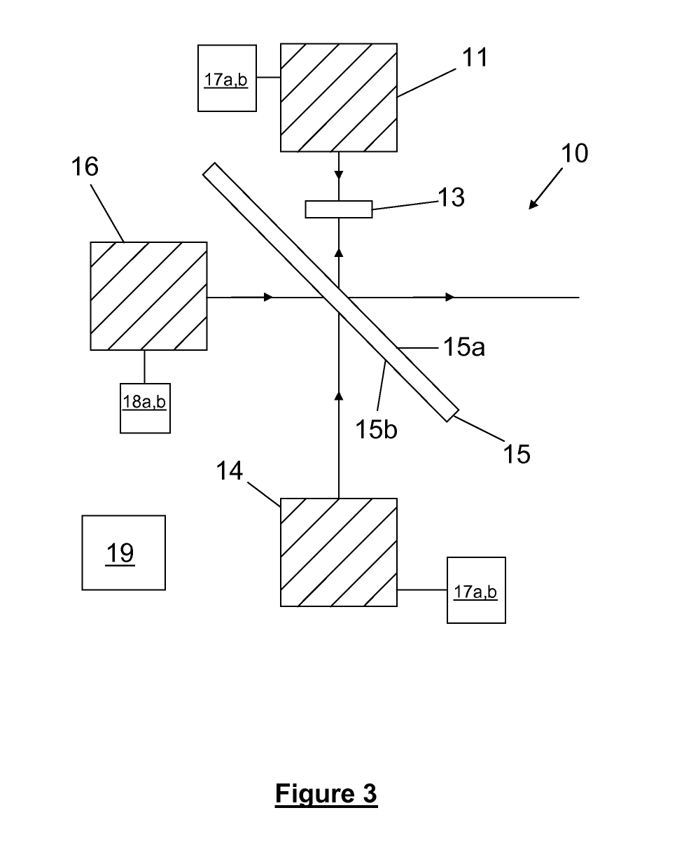

FIG. 3 is a schematic illustration of a radiation generating apparatus comprising a third radiation generating source, according to an alternative embodiment of the present invention;

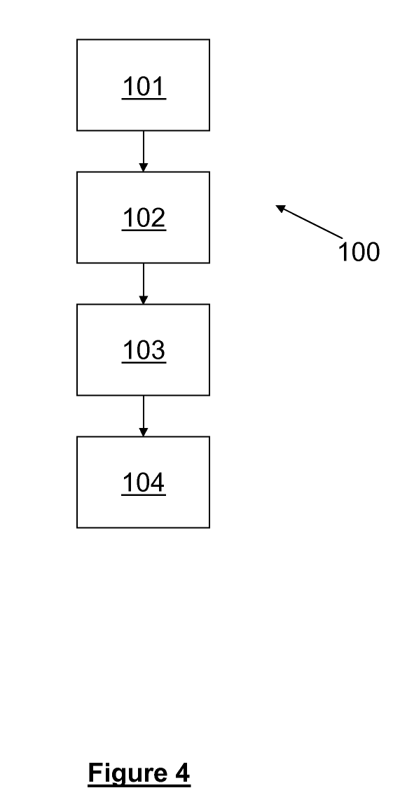

FIG. 4 is a flow chart illustrating the steps associated with the method of generating radiation according to an embodiment of the present invention.

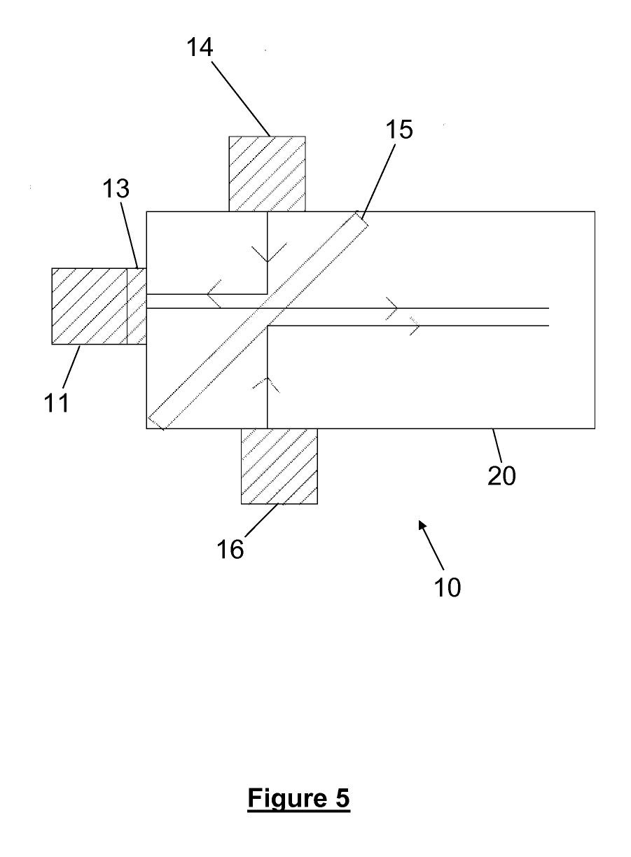

FIG. 5 is a schematic illustration of the radiation generating apparatus illustrated in FIG. 2, enclosed within a housing;

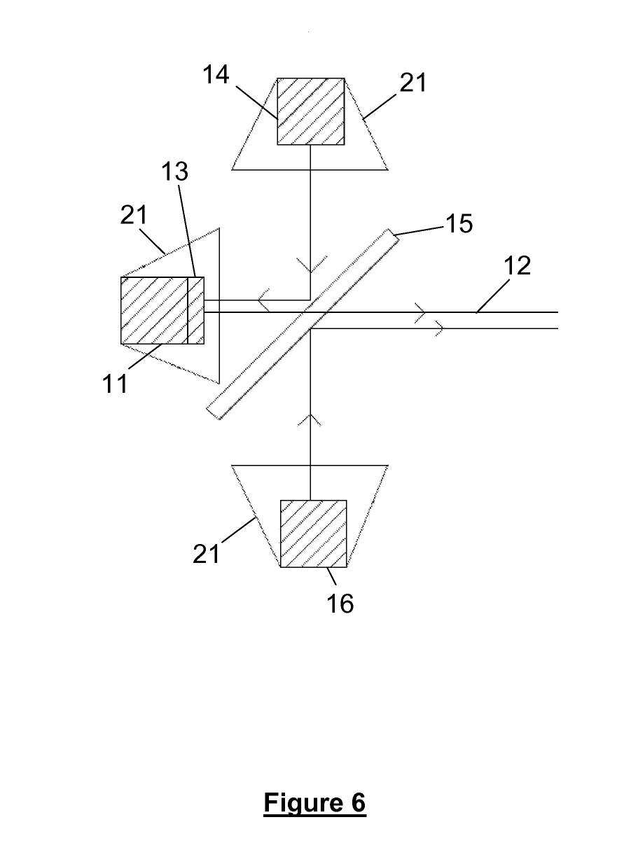

FIG. 6 a is a schematic illustration of the radiation generating apparatus illustrated in FIG. 2 further comprising a reflecting arrangement for collecting radiation generated by the radiation generation sources;

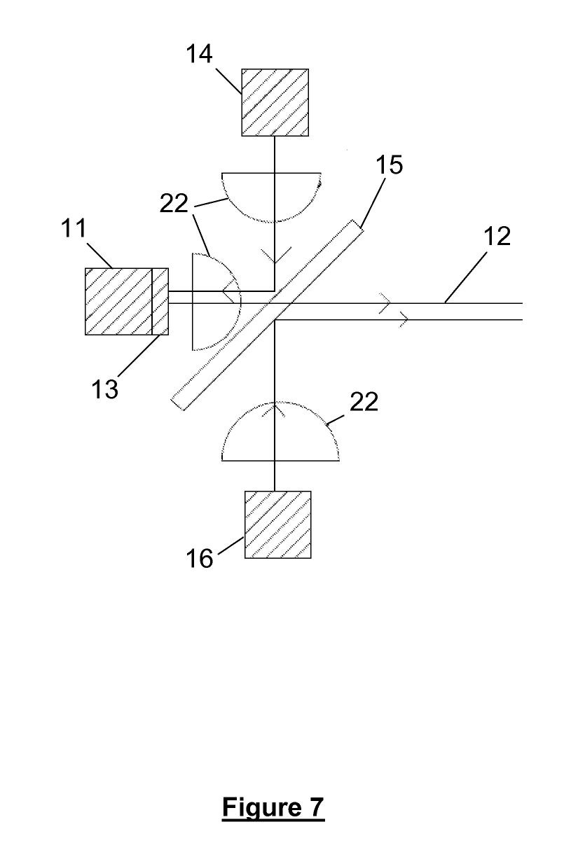

FIG. 7 is a schematic illustration of the radiation generating apparatus illustrated in FIG. 2 further comprising a lens arrangement for collecting radiation generated by the radiation generation sources;

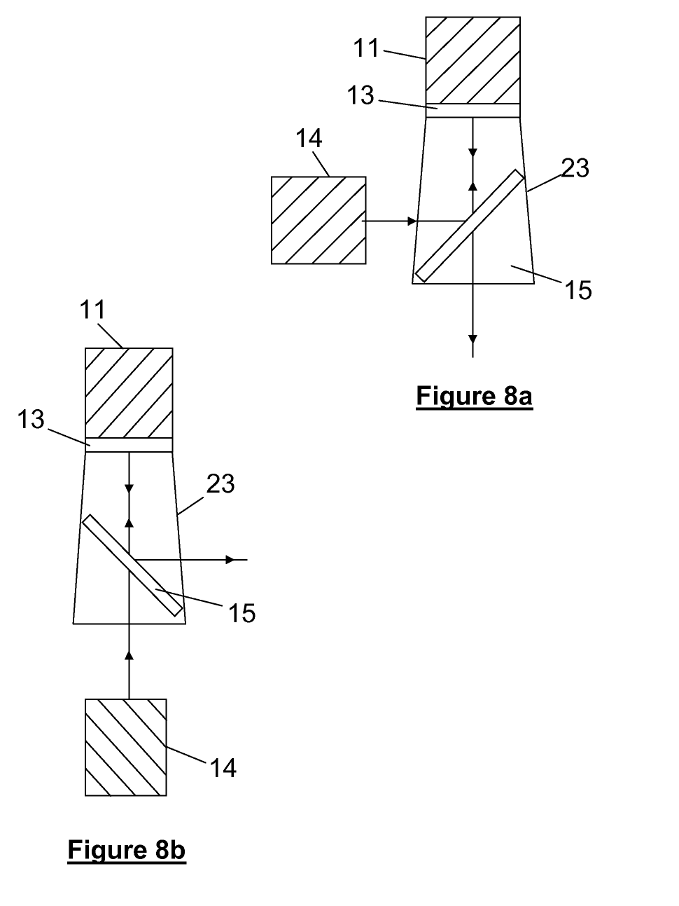

FIG. 8a is a schematic illustration of the radiation generating apparatus illustrated in FIG. 2 with the filter enclosed within a collimator; and,

FIG. 8b is a schematic illustration of the radiation generating apparatus illustrated in FIG. 3, with the filter enclosed within a collimator.

Referring to the drawings, and initially FIG. 1, there is illustrated a schematic illustration of radiation generating apparatus 10 according to an embodiment of the present invention. The apparatus 10 is arranged to generate white light, namely radiation comprising a range of wavelengths which span the visible part of the electromagnetic spectrum. In particular, the apparatus 10 provides for a bright white light source which is suitable for use with endoscopes (not shown) in the viewing of tissue in vivo. However, it is to be appreciated that the apparatus 10 may be used to generate radiation comprising a different range of wavelengths.

The apparatus 10 illustrated in FIG. 1 comprises a first radiation generating source 11, such as a light emitting diode (LED) or laser, which is arranged to generate a short narrowband of wavelengths which peak in the range of 285 nm to 460 nm (ultra-violet to blue), for example. The radiation generated from the first source 11 is directed along a first direction, along an optical axis 12 of the apparatus 10, onto a block of photoluminescent material 13, which may comprise a semiconductor crystal, or a plurality of phosphors or nano-dots for example. In the illustrated example, the photoluminescent material 13 is separated from the source 11, however it is to be appreciated that the material 13 may be mounted upon the source 11 or that the source 11 may be immersed within the material 13.

The apparatus further comprises a second radiation generating source 14 which is similarly arranged to generate a short narrowband of wavelengths which peak in the range of 285 nm to 460 nm (ultra-violet to blue), however, it is to be appreciated that an alternative wavelength range may be selected. The radiation from the second source 14 is initially directed substantially perpendicular to the optical axis 12 of the apparatus 10 onto a front surface 15a of a dichroic filter 15, which may comprise a long pass filter arranged to pass long wavelengths but reflect short wavelengths, or a notch filter which is arranged to pass a selected range of wavelengths and reflect wavelengths outside the selected range, for example. The filter 15 comprises a substantially planar disc which is orientated at substantially 45° to the optical axis 12, so that the radiation from the second source 14 becomes directed along a second direction which is along the optical axis 12 but substantially opposite the first direction. In this manner, the first and second sources 11, 14 are arranged to illuminate the same area of the photoluminescent material 13 so that the material 13 receives twice the optical power compared with a single source thereby enabling a more intense photoluminescent generation of radiation. Moreover, since the same area of material 13 is illuminated, then the entendue of the apparatus 10 is preserved which provides for a more efficient capture of the photoluminescent radiation so that the photoluminescent radiation can be redirected as required.

In the illustrated embodiment, the photoluminescent material 13 is arranged to generate radiation comprising a broad band of wavelengths which span from the blue to the red region of the electromagnetic spectrum, namely 460 nm to 700 nm to generate a bright white light source. Accordingly, in situations where the filter 15 is arranged to pass wavelengths in this range then the ultraviolet light generated from the first and second sources 11, 14 will be reflected at the filter 15, whereas the generated photoluminescent radiation will be permitted to pass through the filter 15, for subsequent application in endoscopy, for example.

In situations whereby the radiation generated by the photoluminescent material 13 is deficient in a desired range of wavelengths, then in an alternative embodiment, the filter 15 may be further arranged to pass a sub-range of wavelengths generated by the first source 11 to supplement the range of wavelengths generated from the photoluminescent material 13. In this respect, the filter 15 may be arranged to pass a blue component of radiation for example to supplement the wavelengths generated by the photoluminescent material in producing white light for example.

In an alternative embodiment, as illustrated in FIG. 2 of the drawings, in which the filter 15 removes (namely, reflects) desired wavelengths, such as the blue component, then a third radiation generating source 16 may be used to re-introduce the blue component into the radiation that passes through the filter 15. The third source 16 may be arranged to generate a short narrowband of wavelengths, similar to the first and second sources 11, 14 which peak in the blue range of the electromagnetic spectrum. The radiation from the third source 16 is directed upon the rear 15b of the filter 15 so that the radiation becomes reflected off the filter 15 and along the optical axis 12 to combine with the radiation generated from the photoluminescent material 13.

The radiation generated by the apparatus is a time averaged combination of the radiation generated from the photoluminescent material 13. Accordingly, in situations where wavelengths are removed from the desired range of wavelengths by the filter 15, then the removed wavelengths can be re-introduced by interleaving the removed wavelengths at a time when the other wavelengths of the desired range are not being generated. For example, in an embodiment of the present invention, the first and second radiation sources 11, 14 may be driven with a pulsed electrical supply 17a, so that radiation generated by the photoluminescent material 13 becomes generated intermittently. The power supply to third source 16 may be similarly driven with a pulsed electrical supply 18a, but controlled via a controller 19 so that the radiation becomes generated by the third source 16 at a time when the first and second sources 11, 14 are off. This arrangement is found to reduce the power consumption while providing a time averaged white light source, for example.

In an alternative embodiment of the present invention, the radiation generating sources 11, 14, 16 may be driven with a continuous power supply 17b and the filter 15 may comprise a plurality of filter portions 15c which extend around the disc and which are angularly separated by a plurality of reflecting portions 15d, as illustrated in FIG. 2b of the drawings. The filter portions 15c are arranged to provide the same optical filtering as described above, however, the reflecting portions 15d are arranged to reflect the wavelengths generated by the first, second and third sources 11, 14, 16, in addition to those generated by photoluminescent material 13.

The filter or disc 15 is arranged to rotate about an axis which extends through the centre thereof, substantially perpendicular to the plane of the disc, and the radiation from the first, second and third sources 11, 14, 16 are directed upon the disc at a common position which is intermediate the centre and peripheral region of the disc. Accordingly, as the disc rotates, the radiation generated by the photoluminescent material 13 and that generated by the third source 16 will pass along the optical axis 12 at separated times, but will provide a time averaged white light output.

In each of the above described embodiments, the radiation from the second source 14 is directed onto the photoluminescent material 13 by reflecting off the filter 15. However, in an alternative embodiment, as illustrated in FIG. 3 of the drawings, the radiation from the second source 14 may instead be directed onto the material 13 by passing directly through the filter 13. In this embodiment, the filter 15 may be arranged to pass short wavelengths, such as in the range spanning between the ultra-violet and blue regions of the electromagnetic spectrum and reflect wavelengths in the visible region of the spectrum. In this embodiment, the third radiation source 16 would similarly direct a short narrowband of wavelengths, which peak in the blue range of the electromagnetic spectrum, similar to the first and second sources 11, 14. However, in contrast to the above described embodiments, the radiation from the third source 16 is arranged to pass through the filter 15 to combine with the reflected white radiation generated from the photoluminescent material 13.

In this embodiment and in situations whereby the radiation generated by the photoluminescent material 13 is deficient in a desired range of wavelengths (similar to that described above), then the filter 15 may be further arranged to reflect a sub-range of wavelengths generated by the first source 11 to supplement the range of wavelengths generated from the photoluminescent material 13. In this respect, the filter 15 may be arranged to reflect a blue component of radiation for example, to supplement the wavelengths generated by the photoluminescent material in producing white light, for example.

Referring to FIG. 4 of the drawings, there is illustrated a method 100 of generating radiation according to an embodiment of the present invention. Accordingly, in order to generate a white light source using the apparatus according to the above described embodiments the method comprises first illuminating the photoluminescent material with radiation from the first and second sources at step 101, from a first and second direction respectively, which are substantially collinear but opposite directions. In accordance with the embodiment illustrated in FIG. 2 of the drawings, the method further comprises selectively powering the first and second sources for a first predetermined time at step 102 and selectively powering the third source for a second predetermined time which is separate from and non-overlapping with the first time, at step 103. The method further comprises collecting the radiation output from the photoluminescent material and the third source, as necessary at step 104, namely the white light, so that the white light can be utilized for example in illuminating tissue during endoscopic surgery.

In an alternative embodiment of the present invention as illustrated in FIG. 5 of the drawings, the filter 15 is housed within a reflective enclosure 20 or waveguide, and the radiation generated by the first, second and third source 11, 14, 16 is coupled into the enclosure 20. This is found to minimise any leakage of radiation from the apparatus and thus improves the efficiency of the apparatus 10. In this embodiment, the photoluminescent material 13 is mounted directly upon the first radiation source 11, however it is to be appreciated that the photoluminescent material 13 may be disposed within the enclosure 20 or waveguide.

In further embodiments, as illustrated in FIGS. 6 and 7 of the drawings, the radiation generated by the radiation sources 11, 14, 16 and the photoluminescent material 13 is collected by a reflecting arrangement 21 disposed around the sources 11, 14, 16 and material 13, or by a plurality of lenses 22, respectively, which are arranged to couple the radiation into an optical fibre (not shown) for example, for subsequent use, such as in endoscopy.

In yet a further embodiment as illustrated in FIG. 8 of the drawings, the dichroic filter may be enclosed within a tapered glass collimator, which may be solid or hollow. The glass collimator comprises a frusto-conical shape for example, and comprises a cross-sectional area which reduces along the length thereof in a direction which is from the dichroic filter toward the photoluminescent material.

Referring to FIG. 8a of the drawings, in which the dichroic filter 15 of FIG. 2 is enclosed within the collimator 23, the radiation from the second radiation source 14 is arranged to strike the filter 15 by passing through the side of the collimator 23. The radiation is permitted to pass through the side of the glass collimator 23, by virtue of the substantially perpendicular incident angle. However upon reflecting from the filter 15, the radiation from the second radiation source 14 becomes incident upon the interface between the glass collimator 23 and the surrounding environment, such as air, at a reduced angle, which causes the radiation to totally internally reflect onto the photoluminescent material 13, thereby increasing the generation of light from the material 13.

In contrast upon referring to FIG. 8b of the drawings, in which the dichroic filter 15 of FIG. 3 is enclosed within the collimator 23, the light from the second radiation source 14 is arranged to pass into the collimator 23 by passing through the filter 15, and is steered onto the photoluminescent material 13 by total internal reflection at the glass/air interface of the collimator 23 (for example), owing to the glancing incidence of the radiation at the interface.

Moreover, light which becomes generated from the photoluminescent material 13 of the apparatus illustrated in FIGS. 8a and 8b is further steered by the same total internal reflection process at the glass/air interface of the collimator 23 onto the filter 15, to facilitate a more efficient coupling of the light from the filter 15 into an optical system, such as an endoscopic system.

From the foregoing therefore, it is evident that the apparatus and method provide for an improved generation of white light.

1. Radiation generating apparatus comprising:
a first radiation generating source for generating radiation comprising a first range of wavelengths;
a second radiation generating source for generating radiation comprising a second range of wavelengths;
a photoluminescent material which is arranged to absorb radiation in the first and second wavelength range and generate radiation comprising a third range of wavelengths, the material comprising a first facet which is arranged to receive radiation from the first radiation source and a second facet which is arranged to receive radiation from the second radiation source;
wherein the first radiation source is arranged to illuminate the first facet from a first direction and the second radiation source is arranged to illuminate the second facet from a second direction, which is substantially collinear with the first direction, and wherein, the first and second directions are substantially opposite directions.

2. Apparatus according to claim 1, wherein the first and second radiation generating sources are substantially similar sources and the first and second wavelength ranges are substantially similar ranges.

3. Apparatus according to claim 1, wherein the first and second directions are collinear with an optical axis of the apparatus.

4. Apparatus according to any preceding claim 1, further comprising a filter which is arranged to substantially pass radiation in the third wavelength range.

5. Apparatus according to claim 4, wherein the filter is arranged to substantially reflect radiation in the first and second wavelength ranges.

6. Apparatus according to claim 4, wherein the filter is arranged to pass radiation in a sub-range of wavelengths of the first wavelength range.

7. Apparatus according to claim 4, wherein radiation in the second wavelength range is directed upon the second facet by reflecting off the filter.

8. Apparatus according to claim 1, further comprising a filter which arranged substantially reflect radiation in the third wavelength range.

9. Apparatus according to claim 8, wherein the filter is arranged to substantially pass radiation in the first and second wavelength ranges.

10. Apparatus according to claim 8, wherein the filter is arranged to reflect radiation in a sub-range of wavelengths of the first wavelength range.

11. Apparatus according to claim 8, wherein the radiation in the second wavelength range is directed upon the second facet by passing through the filter.

12. Apparatus according to claim 4, wherein the filter is substantially planar and comprises a disc which is orientated at substantially 45° to the first and second directions.

13. Apparatus according to claim 12, wherein the filter comprises at least a reflecting portion and at least a filtering portion which are angularly separated around the disc.

14. Apparatus according to claim 12, wherein the disc is arranged to rotate about an axis which extends though through a centre of the disc, substantially perpendicular to the plane of the disc.

15. Apparatus according to any of claims claim 4, wherein the filter comprises a dichroic filter.

16. Apparatus according to claim 1, further comprising a third radiation generating source which is arranged to generate radiation comprising the first or second wavelength range.

17. Apparatus according to claim 16, wherein the radiation generated by the third radiation source is arranged to combine with the radiation generated by the photoluminescent material to generate a fourth range of wavelengths.

18. Apparatus according to claim 16, wherein the radiation generated by one or more of the first, second and third radiation sources, together with that generated by the photoluminescent material is enclosed within a waveguide.

19. Apparatus according to claim 1, further comprising at least one radiation collecting arrangement for collecting the radiation which is generated by the radiation sources.

20. Apparatus according to claim 19, wherein the at least one collecting arrangement comprises a lens arrangement and/or a reflecting arrangement.

21. Apparatus according to claim 1, wherein the first and second wavelength ranges comprise at least ultra-violet radiation and the third wavelength range comprises at least a green to red wavelength range of the electromagnetic spectrum.

22. Apparatus according to claim 1, wherein the third wavelength range or as appropriate the fourth wavelength range, spans a visible range of the electromagnetic spectrum to generate substantially white light.

23. A method of generating radiation comprising a range of wavelengths from a photoluminescent material, the method comprising the use of a first radiation source which is arranged to generate radiation comprising a first range of wavelengths and a second radiation source which is arranged to generate radiation comprising a second range of wavelengths, the method comprising the steps of:
illuminating a photoluminescent material from a first direction using radiation from the first radiation source to generate radiation comprising a third range of wavelengths; and,
illuminating the photoluminescent material from a second direction, which is substantially collinear with the first direction and substantially opposite the first direction, using radiation from the second radiation source, to further generate radiation comprising the third range of wavelengths.

24. A method according to claim 23, comprising directing the radiation from the second radiation source in the second direction, by reflecting the radiation off a filter.

25. A method according to claim 23, comprising directing the radiation from the second radiation source in the second direction by passing the radiation through a filter.

26. A method according to claim 24, further comprising combining the radiation generated by the photoluminescent material with radiation from a third radiation source, which is arranged to generate radiation within the first or second wavelength range, to generate a fourth range of wavelengths.

27. A method according to claim 26, further comprising powering at least one of the first, second and third radiation generating sources with a pulsed power supply.
